(19) United States
(12) Patent Application Publication
(10) Pub. No.: US 2022/0261238 A1
(43) Pub. Date: Aug. 18, 2022

(54) METHOD AND SYSTEM FOR DEPLOYING THIRD-PARTY APPLICATION TO MICROCONTROLLER BY MEANS OF EDGE ASSISTANCE

(71) Applicant: FOSHAN POLYTECHNIC, Foshan (CN)

(72) Inventors: Zhiliang XIAO, Foshan (CN); Shaowen ZENG, Foshan (CN); Yiyuan HUANG, Foshan (CN)

(21) Appl. No.: 17/614,278

(22) PCT Filed: Sep. 11, 2020
(86) PCT No.: PCT/CN2020/114748

§ 371 Date: Nov. 24, 2021

(30) Foreign Application Priority Data
Nov. 13, 2019 (CN) 201911104319.8

(51) Int. Cl. G06F 8/658; G06F 8/41

(52) U.S. Cl. CPC G06F 8/658; G06F 8/44

(57) ABSTRACT

The present disclosure provides a method and system for deploying a third-party application to a microcontroller using edge assistance. The method includes: sending an instruction packet to an edge server, applying the instruction packet to an intermediate bytecode content of a current node temporarily stored on the edge server, and compiling an updated intermediate bytecode of a device as a corresponding native instruction set code; assigning a size of each application partition according to a compilation result; and statically or dynamically linking each application to a corresponding position according to an assigned memory address of each application to generate a binary image, and downloading the binary image into an application node, thereby completing update of the application node.

### CROSS REFERENCE TO RELATED APPLICATION

The present application is a 35 U.S.C. § 371 national phase application of PCT International Application No. PCT/CN2020/114748, having an international filing date of Sep. 11, 2020, and entitled “METHOD AND SYSTEM FOR DEPLOYING THIRD-PARTY APPLICATION TO MICROCONTROLLER USING EDGE ASSISTANCE” claiming priority to Chinese Patent Application No. 201911104319.8, filed with the China National Intellectual Property Administration (CNIPA) on Nov. 13, 2019, and entitled “METHOD AND SYSTEM FOR DEPLOYING THIRD-PARTY APPLICATION TO MICROCONTROLLER BY MEANS OF EDGE ASSISTANCE”, the disclosures of all of which are incorporated herein by reference in their entireties.

### TECHNICAL FIELD

The present disclosure relates to the technical field of application deployment and embedded systems, and in particular, to a method and system for deploying a third-party application to a microcontroller.

### BACKGROUND ART

With technological advancements, various embedded devices, non-embedded devices and compositions thereof are becoming more complicated, and thus are internally classified into multiple protection domains that run independently. The requirements for dynamically deploying multiple applications on the devices are also rising rapidly. However, the microcontroller is only provided with a memory protection unit (MPU) but not a memory management unit (MMU). The MMU rather than the MPU can implement mapping from a virtual address to a physical address, indicating that a static user is required for each partition in software development, or otherwise, a position independent code (PIC) is used.

There have been three application deployment methods for this system, i.e., statically compiling codes to a fixed address, using the PICs, and downloading firmware from a cloud.

The first scheme is to assign the size of each partition of the static user in software development. Specifically, third-party developers write codes of each partition according to system requirements, such that third-party applications are compiled to obtain their occupied memory sizes; and then the users or automatic tools assign an exact position for each section of the third-party applications according to data, statically compile the third-party applications and link the applications to the positions. Though avoiding the PICs, lowering the system complexity and development burden, and saving the memory space, the present scheme makes update of the applications difficulty. This is because any new application with a larger size than the original application cannot be put into the original partition during application update; the reservation of a partition space for future update is wasteful; and at last, the addition of any new partition in the system is also very complicated as no virtual address is present and the new third-party application must find a gap in the existing memory layout of the applications.

The second scheme is to use the PICs. The third-party developers compile the applications as PICs, and the power-on operating system or Bootloader assigns layouts of code segments and/or data segments of these applications in the memory. Though solving fragmentation of the memory layouts of the applications, the scheme uses the PICs, with the low execution efficiency, low code density and poor security.

The third scheme is to recompile the firmware statically at the cloud, reassign each protection domain and download the firmware, to avoid the problems of the previous two methods. However, re-downloading the whole software package from the cloud often consumes a lot of network bandwidths, and this is particularly the case for a charging network. Moreover, all applications on the device to be updated must be reloaded through the network, further aggravating the problem.

### SUMMARY

In view of this, an objective of the present disclosure is to provide a method and system for deploying a third-party application to a microcontroller using edge assistance. The present disclosure is implemented by sending an instruction packet to an edge server, applying the instruction packet to an intermediate bytecode content of a current node temporarily stored on the edge server, and compiling an updated intermediate bytecode of a device as a corresponding native instruction set code; assigning a size of each application partition according to a compilation result; and statically or dynamically linking each application to a corresponding position according to an assigned memory address of each application to generate a binary image, and downloading the binary image into an application node, thereby completing update of the application node.

To achieve the above objective, the present disclosure provides a method for deploying a third-party application to a microcontroller using edge assistance, including:

S100: sending, by an application change acquisition module, any one or more of a differential update instruction, a delete instruction and a download instruction, packing the instructions into an instruction packet, and transmitting the instruction packet to an edge server;

S200: receiving, by an application information acquisition module, the instruction packet, unpacking the instruction packet, and applying a content of the instruction packet to an intermediate bytecode content of a current node temporarily stored on the edge server;

S300: compiling, by a code generation module, an updated intermediate bytecode of a device as a corresponding native instruction set code;

S400: assigning, by a memory address assignment module, a size of each application partition according to a compilation result;

S500: statically or dynamically linking, by an application linking module, each application to a corresponding position according to an assigned memory address of each application to generate a binary image; and

S600: downloading, by an application loading module, the binary image into an application node, thereby completing update of the application node.

Further, a system for deploying a third-party application to a microcontroller using edge assistance on which the method relies may include: the application change acquisition module, the application information acquisition module, the code generation module, the memory address assignment module, the application linking module and the application loading module, where the application change acquisition module runs on a developer machine of a user or on a client; the application information acquisition module, the code generation module, the memory address assignment module and the application linking module run on the edge server; and the application loading module runs on an Internet of things (IoT) node.

Further, the sending, by an application change acquisition module, any one or more of a differential update instruction, a delete instruction and a download instruction in S100 may include: compiling, by the application change acquisition module, when a user selects to update an application, the application as an intermediate bytecode, comparing the intermediate bytecode with an intermediate bytecode of an original application, and sending a differential update instruction of an application containing a net change of the bytecode; sending, when the user selects to delete an application, a delete instruction of the application; and compiling, when the user selects to add an application, the added application as an intermediate bytecode, and sending a download instruction of an application containing the intermediate bytecode.

Further, in S100, when a group of third-party applications are first deployed to an empty IoT node, all applications may be considered as being added and a download instruction for each of the applications may be generated.

Further, in S100, one or more edge servers may be provided and can be connected to an IoT node in any form; and the edge server may provide a user with an access to enter an IoT network or a function to communicate with other server devices.

Further, the applying a content of the instruction packet to a current node temporarily stored on the edge server in S200 may include: receiving, by the application information acquisition module running on the edge server, the instruction packet, unpacking the instruction packet, and applying the content of the instruction packet to the intermediate bytecode content of the current node temporarily stored on the edge server; applying, in response to the differential update instruction, the differential update instruction to an intermediate bytecode of an original application temporarily stored on the edge server; deleting, in response to the delete instruction, the intermediate bytecode of the original application; adding, in response to the download instruction, an intermediate bytecode of a new application to the intermediate bytecode content of the node; and ensuring that a final state of the intermediate bytecode of the node is still temporarily stored on the edge server, where the node is a network node of the IoT or an embedded device.

The present disclosure further provides a system for deploying a third-party application to a microcontroller using edge assistance, including: a memory, a processor and a computer program stored in the memory and capable of running on the processor, where the processor executes the computer program to run the following modules of the system:

an application change acquisition module, configured to send any one or more of a differential update instruction, a delete instruction and a download instruction, pack the instructions into an instruction packet, and transmit the instruction packet to an edge server;

an application information acquisition module, configured to receive the instruction packet, unpack the instruction packet, and apply a content of the instruction packet to an intermediate bytecode content of a current node temporarily stored on the edge server;

a code generation module, configured to compile an updated intermediate bytecode of a device as a corresponding native instruction set code;

a memory address assignment module, configured to assign a size of each application partition according to a compilation result;

an application linking module, configured to statically or dynamically link each application to a corresponding position according to an assigned memory address of each application to generate a binary image; and

an application loading module, configured to download the binary image into an application node, thereby completing update of the application node.

Based on the specific embodiments of the present disclosure, the present disclosure has the following technical effects: The technical solution greatly simplifies the application update of the microcontroller or the IoT node without the virtual memory, and is well-suited for memory layouts of various third-party applications.

First, as a copy of intermediate bytecode is temporarily stored on the edge server, the present disclosure only transmits an updated application but not all applications from the developer machine of the user to the edge server (except that the applications are first deployed), which greatly reduces the usage of network bandwidths and accelerates the deployment of the applications.

Second, the present disclosure makes the use of the PICs unnecessary, to greatly improve the efficiency of code execution on the resource-constrained microcontroller, and greatly reduce the memory usage.

Third, the present disclosure can generate the statically linked code, and can also reassign any memory layout, making the deployment of a larger application or the addition of a new application possible.

Fourth, as most steps are executed on the resource-rich developer machine and the edge server, and the resource-constraint microcontroller is only required to have a function of updating the whole binary image, the present disclosure greatly lowers the software complexity and development burden of the microcontroller to minimize the cost.

### BRIEF DESCRIPTION OF THE DRAWINGS

To describe the technical solutions in the embodiments of the present disclosure or in the prior art more clearly, the accompanying drawings required for the embodiments are briefly described below. Apparently, the accompanying drawings in the following description show merely some embodiments of the present disclosure, and a person of ordinary skill in the art may still derive other accompanying drawings from these accompanying drawings without creative efforts.

FIG. 1 is a flow chart of a method for deploying a third-party application to a microcontroller using edge assistance according to an embodiment of the present disclosure.

FIG. 2 is a structure view of a system for deploying a third-party application to a microcontroller using edge assistance according to an embodiment of the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by the person of ordinary skill in the art based on the embodiments of the present disclosure without creative efforts shall fall within the protection scope of the present disclosure.

An objective of the present disclosure is to provide a method and system for deploying a third-party application to a microcontroller using edge assistance. The present disclosure is implemented by sending an instruction packet to an edge server, applying the instruction packet to an intermediate bytecode content of a current node temporarily stored on the edge server, and compiling an updated intermediate bytecode of a device as a corresponding native instruction set code; assigning a size of each application partition according to a compilation result; and statically or dynamically linking each application to a corresponding position according to an assigned memory address of each application to generate a binary image, and downloading the binary image into an application node, thereby completing update of the application node.

To make the above-mentioned objectives, features, and advantages of the present disclosure clearer and more comprehensible, the present disclosure will be further described in detail below with reference to the accompanying drawings and the specific embodiments.

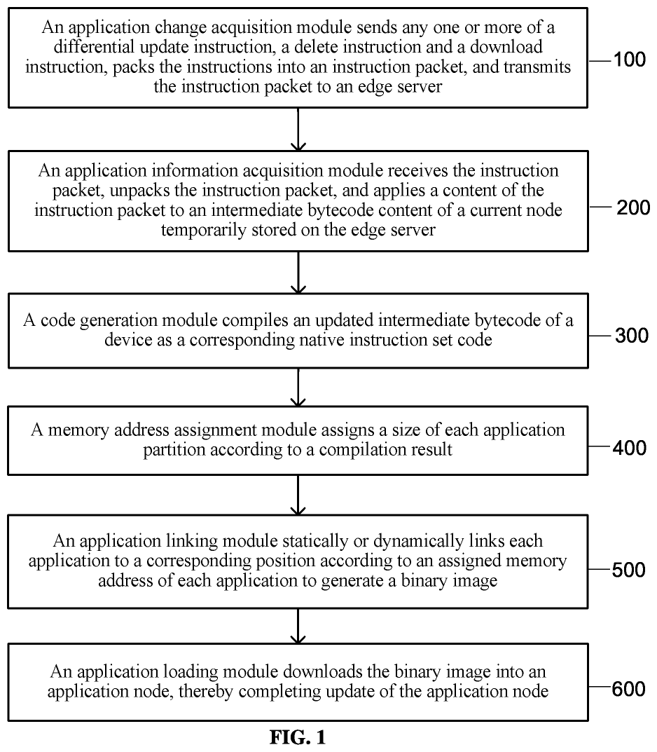

FIG. 1 is a flow chart of a method for deploying a third-party application to a microcontroller using edge assistance according to the present disclosure. The method for deploying a third-party application to a microcontroller using edge assistance according to an embodiment of the present disclosure will be described below in combination with FIG. 1.

The present disclosure discloses a method for deploying a third-party application to a microcontroller using edge assistance. The method includes: an application change acquisition module, an application information acquisition module, a code generation module, a memory address assignment module, an application linking module and an application loading module. The application change acquisition module runs on a developer machine of a user. The application information acquisition module, the code generation module, the memory address assignment module and the application linking module run on an edge server. The application loading module runs on an IoT node.

The method specifically includes the following steps:

(1) The user is allowable to update an application, delete an application or add an application. The application change acquisition module compiles, when the user updates an application, the application as an intermediate bytecode, compares the intermediate bytecode with an intermediate bytecode of an original application, and sends a differential update instruction (Diff) of an application containing a net change of the bytecode; sends, when the user deletes an application, a delete instruction of the application; and compiles, when the user adds an application, the added application as an intermediate bytecode, and sends a download instruction of an application containing the intermediate bytecode.

(2) When a group of third-party applications are first deployed to an empty IoT node, all applications are considered as being added and a download instruction for each of the applications is generated.

(3) The application change acquisition module receives the differential update instruction, the delete instruction and the download instruction, packs them into an instruction packet and downloads the instruction packet to the edge server from the developer machine of the user. One or more edge servers may be provided and may be connected in any form, provided that the implemented functions are equivalent to those of the modules described in the present disclosure.

(4) The application information acquisition module running on the edge server receives the instruction packet, unpacks the instruction packet, and applies a content of the packet to an intermediate bytecode content of a current node temporarily stored on the edge server; applies, in response to the differential update instruction, the differential update instruction to an intermediate bytecode of an original application temporarily stored on the edge server; deletes, in response to the delete instruction, the intermediate bytecode of the original application; adds, in response to the download instruction, an intermediate bytecode of a new application to the intermediate bytecode content of the node; and implements an effect that a final state of the intermediate bytecode of the node is still temporarily stored on the edge server.

(5) The edge server compiles an updated intermediate bytecode of a device as a corresponding native instruction set code by invoking the code generation module.

(6) The edge server assigns a size of each application partition according to a compilation result by invoking the memory address assignment module.

(7) The edge server statically or dynamically links, by invoking the application linking module, each application to a corresponding position according to an assigned memory address of each application to generate a binary image that can be downloaded into the IoT node. When the static link is used, the PICs can be avoided to improve the operation efficiency of the system.

(8) The edge server downloads the binary image into an application node by invoking the application loading module running on the IoT node, thereby completing update of the application node.

A system for deploying a third-party application to a microcontroller using edge assistance on which the method relies includes: an application change acquisition module, an application information acquisition module, a code generation module, a memory address assignment module, an application linking module and an application loading module, where the application change acquisition module runs on a developer machine of a user or on a client; the application information acquisition module, the code generation module, the memory address assignment module and the application linking module run on an edge server; and the application loading module runs on an IoT node.

The following descriptions are briefly made on two specific embodiments during implementation. In the embodiments, it is assumed that there are A, B, C and D applications, and no initial application on the IoT node.

### Embodiment 1

(1) The user deploys the A, B and C applications on the IoT node, and sends an instruction to the application change acquisition module on the developer machine.

(2) The application change acquisition module receives the instruction, and generates download instructions Ad, Bd and Cd for the three applications. These download instructions respectively contain intermediate bytecode Ai, Bi and Ci of the A, B and C applications.

(3) The edge server receives the Ad, Bd and Cd. As the present IoT node is empty, the temporarily stored intermediate bytecode of the node is empty. At this time, the edge server updates the temporarily stored intermediate bytecode as the Ai, Bi and Ci.

(4) The edge server compiles the Ai, Bi and Ci through the code generation module as local codes Ac, Bc and Cc capable of being executed on the microcontroller.

(5) The edge server assigns an appropriate address to the Ac, Bc and Cc through the memory address assignment module.

(6) The edge server links the Ac, Bc and Cc with the application linking module as a binary image capable of being downloaded into the IoT node finally, and downloads the image into the IoT node for running.

### Continued, Embodiment 2

(7) The user adds the application D to the IoT node, updates the version of the C as C2 and removes the application B.

(8) The application change acquisition module obtains the instruction, and generates a download instruction Dd for the application D, a differential update instruction Cu for the application C and a delete instruction Br for the application B. The Dd contains the intermediate bytecode Di of the D, the Cu contains contents making the intermediate bytecode C2i of the C2 different from the Ci, and Br only contains the delete instruction.

(9) The edge server receives the Dd, Cu and Br. As the present intermediate bytecode temporarily stored is the Ai, Bi and Ci, a combination of Ai, Bi, Ci and Di is obtained by applying the Dd, a combination of Ai, Bi, C2i and Di is obtained by applying the Cu, and a combination of Ai, Bi, C2i and Di is obtained by applying the Br, and thus the final state for the intermediate bytecode is obtained.

(10) The edge server compiles the Ai, C2i and Di through the code generation module as local codes Ac, C2c and Dc capable of being executed on the microcontroller.

(11) The edge server assigns an appropriate address to the Ac, C2c and Dc through the memory address assignment module.

(12) The edge server links the Ac, C2c and Dc with the application linking module as a binary image capable of being downloaded into the IoT node finally, and downloads the image into the IoT node for running.

As can be seen from the embodiments, only necessary contents are transmitted during update as the intermediate bytecode is temporarily stored on the edge server. Moreover, the application partition is compiled to the user, so the problems that the fixedly assigned partition cannot be updated flexibly and added with the new application are avoided. In addition, as the application is statically linked at last, the execution efficiency and the memory capacity are not affected by the PICs.

The third-party application is the program compiled by the user, rather than the program from the embedded device manufacturer or the IoT hardware manufacturer.

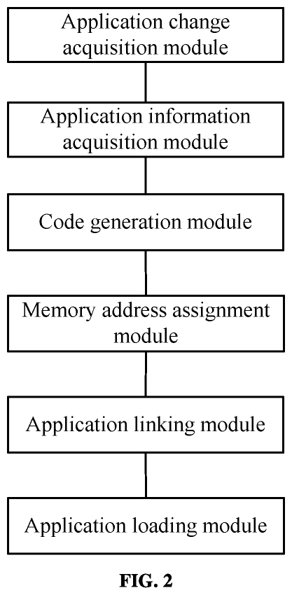

An embodiment of the present disclosure further provides a system for deploying a third-party application to a microcontroller using edge assistance. FIG. 2 is a structural view of a system for deploying a third-party application to a microcontroller using edge assistance according to the present disclosure. The system for deploying a third-party application to a microcontroller using edge assistance in the embodiment includes: a processor, a memory and a computer program stored in the memory and capable of running on the processor, where the processor executes the computer program to implement the steps in the embodiment of the system for deploying a third-party application to a microcontroller using edge assistance.

The system includes: a memory, a processor and a computer program stored in the memory and capable of running on the processor, where the processor executes the computer program to run the following modules in the system:

an application change acquisition module, configured to send any one or more of a differential update instruction, a delete instruction and a download instruction, pack the instructions into an instruction packet, and transmit the instruction packet to an edge server;

an application information acquisition module, configured to receive the instruction packet, unpack the instruction packet, and apply a content of the instruction packet to an intermediate bytecode content of a current node temporarily stored on the edge server;

a code generation module, configured to compile an updated intermediate bytecode of a device as a corresponding native instruction set code;

a memory address assignment module, configured to assign a size of each application partition according to a compilation result;

an application linking module, configured to statically or dynamically link each application to a corresponding position according to an assigned memory address of each application to generate a binary image; and

an application loading module, configured to download the binary image into an application node, thereby completing update of the application node.

The system for deploying a third-party application to a microcontroller using edge assistance may run on a computing device such as a desktop computer, a notebook, a palmtop computer, and a cloud server. In the system for deploying a third-party application to a microcontroller using edge assistance, the operating systems may include but not limited to the processor and the memory. The person skilled in the art may understand that the embodiments are merely examples of the system for deploying a third-party application to a microcontroller using edge assistance, rather than limits to the system for deploying a third-party application to a microcontroller using edge assistance. The system may include more or fewer components than those in the embodiments, or combine some components or use different components. For example, the system for deploying a third-party application to a microcontroller using edge assistance may further includes an input/output device, a network access device, a bus, or the like.

The processor may be a central processing unit (CPU), and may also be another general-purpose processor, a digital signal processor (DSP), an application specific integrated circuit (ASIC), a field-programmable gate array (FPGA) or another programmable logic device, a discrete gate, a transistor logic device, a discrete hardware component, etc. The general processor may be a microprocessor, or any conventional processor. The processor is a control center of the operating system of the system for deploying a third-party application to a microcontroller using edge assistance, and various parts of the operating system of the system for deploying a third-party application to a microcontroller using edge assistance are connected by using various interfaces and lines.

The memory may be configured to store the computer programs and/or modules. The processor implements various functions of the system for deploying a third-party application to a microcontroller using edge assistance by running or executing the computer programs and/or modules stored on the memory and invoking data stored on the memory. The memory may mainly include a program storage area and a data storage area. The program storage area may store an operating system, an application program required by at least one function (such as a sound playing function and an image playing function), and the like. The data storage area may store data (such as audio data and an address book) created according to use of a mobile phone, and the like. In addition, the memory may include a high-speed random-access memory, and may further include a non-volatile memory, such as a hard disk, an internal storage, a plug-in hard disk, a smart media card (SMC), a secure digital (SD) card, a flash card, at least one magnetic disk storage device, a flash memory device, or another volatile solid-state storage device.

Each embodiment of the present specification is described in a progressive manner, each embodiment focuses on the differences from other embodiments, and the same and similar parts between the embodiments may refer to each other.

In this specification, several examples are used for illustration of the principles and embodiments of the present disclosure. The descriptions of the foregoing embodiments are used to help illustrate the method of the present disclosure and the core principles thereof. In addition, those of ordinary skill in the art can make various modifications in terms of specific embodiments and scope of application in accordance with the teachings of the present disclosure. In conclusion, the contents of the present specification shall not be construed as a limitation to the present disclosure.

1. A method for deploying a third-party application to a microcontroller using edge assistance, comprising:
sending, by an application change acquisition module, any one or more of a differential update instruction, a delete instruction and a download instruction, packing the instructions into an instruction packet, and transmitting the instruction packet to an edge server;
receiving, by an application information acquisition module, the instruction packet, unpacking the instruction packet, and applying a content of the instruction packet to an intermediate bytecode content of a current node temporarily stored on the edge server;
compiling, by a code generation module, an updated intermediate bytecode of a device as a corresponding native instruction set code;
assigning, by a memory address assignment module, a size of each application partition according to a compilation result;
statically or dynamically linking, by an application linking module, each application to a corresponding position according to an assigned memory address of each application to generate a binary image; and
downloading, by an application loading module, the binary image into an application node, thereby completing update of the application node.

2. The method for deploying a third-party application to a microcontroller using edge assistance according to claim 1, wherein a system for deploying a third-party application to a microcontroller using edge assistance on which the method relies comprises: the application change acquisition module, the application information acquisition module, the code generation module, the memory address assignment module, the application linking module and the application loading module, wherein the application change acquisition module runs on a developer machine of a user or on a client; the application information acquisition module, the code generation module, the memory address assignment module and the application linking module run on the edge server; and the application loading module runs on an Internet of things (IoT) node.

3. The method for deploying a third-party application to a microcontroller using edge assistance according to claim 1, wherein the sending, by an application change acquisition module, any one or more of a differential update instruction, a delete instruction and a download instruction in S100 comprises: compiling, by the application change acquisition module, when a user selects to update an application, the application as an intermediate bytecode, comparing the intermediate bytecode with an intermediate bytecode of an original application, and sending a differential update instruction of an application containing a net change of a bytecode; sending, when the user selects to delete an application, a delete instruction of the application; and compiling, when the user selects to add an added application, the added application as the intermediate bytecode, and sending a download instruction of an application containing the intermediate bytecode.

4. The method for deploying a third-party application to a microcontroller using edge assistance according to claim 1, wherein when a group of third-party applications are first deployed to an empty IoT node, all applications are considered as being added and a download instruction for each of the applications is generated.

5. The method for deploying a third-party application to a microcontroller using edge assistance according to claim 1, wherein one or more edge servers are provided and are connected to an IoT node in any form; and the edge server provides a user with an access to enter an IoT network or a function to communicate with other server devices.

6. The method for deploying a third-party application to a microcontroller using edge assistance according to claim 1, wherein the applying a content of the instruction packet to a current node temporarily stored on the edge server comprises: receiving, by the application information acquisition module running on the edge server, the instruction packet, unpacking the instruction packet, and applying the content of the instruction packet to the intermediate bytecode content of the current node temporarily stored on the edge server; applying, in response to the differential update instruction, the differential update instruction to an intermediate bytecode of an original application temporarily stored on the edge server; deleting, in response to the delete instruction, the intermediate bytecode of the original application; adding, in response to the download instruction, an intermediate bytecode of a new application to the intermediate bytecode content of the node; and ensuring that a final state of the intermediate bytecode of the node is still temporarily stored on the edge server, wherein the node is a network node of the IoT or an embedded device.

7. A system for deploying a third-party application to a microcontroller using edge assistance, comprising: a memory, a processor and a computer program stored in the memory and capable of running on the processor, wherein the processor executes the computer program to run the following modules of the system:
an application change acquisition module, configured to send any one or more of a differential update instruction, a delete instruction and a download instruction, pack the instructions into an instruction packet, and transmit the instruction packet to an edge server;
an application information acquisition module, configured to receive the instruction packet, unpack the instruction packet, and apply a content of the instruction packet to an intermediate bytecode content of a current node temporarily stored on the edge server;
a code generation module, configured to compile an updated intermediate bytecode of a device as a corresponding native instruction set code;
a memory address assignment module, configured to assign a size of each application partition according to a compilation result;
an application linking module, configured to statically or dynamically link each application to a corresponding position according to an assigned memory address of each application to generate a binary image; and
an application loading module, configured to download the binary image into an application node, thereby completing update of the application node.
